(19) United States
(12) Patent Application Publication
(10) Pub. No.: US 2006/0110029 A1
(43) Pub. Date: May 25, 2006

(54) Pattern recognizing method and apparatus

(76) Inventors: Masato Kazui, Pittsburg, PA (US); Shigeki Keumi, Yokohama (JP); Tatsuo Miyazoe, Yokohama (JP); Junichi Tanimoto, Chiba (JP); Kazuyuki Maebayashi, Yokohama (JP)

Correspondence Address: MCDERMOTT WILL & EMERY LLP, 600 13TH STREET, N.W., WASHINGTON, DC, 20005-3096, US

(21) Appl. No.: 11/205,011

(22) Filed: Aug. 17, 2005

(30) Foreign Application Priority Data
Nov. 22, 2004 (JP) 2004-336849

(51) Int. Cl. G06K 9/62; G06K 9/46

(52) U.S. Cl. 382/159; 382/190

(57) ABSTRACT

A pattern recognizing method and apparatus are arranged to detect one or more objects with its own individuality belonging to the same category, such as a vehicle or a human's face, by using incremental signs in a manner to correspond with an apparent change caused by the posture variation of the object. For achieving the pattern detection corresponding with the apparent change caused by the posture variation of the object, the statistic quality of the incremental signs is extracted from a database having image data of the objects. The learning of a feature vector composed by using the quality makes it possible to design the most approximate identifier for detecting a pattern.

### BACKGROUND OF THE INVENTION

The present invention relates to a method and an apparatus which are arranged to detect an object having a specific pattern from an image picked up by a camera.

In a substrate inspecting technology dedicated for factory automation or an automatic address reading technology used in an automatic mail sorting machine, conventionally, a specific substrate or wiring pattern is searched for inspecting it or characters written on a mail are recognized. For these technologies has been used a matching method based on the normalized correlation of an image pattern or another matching method based on the feature quantity of a target object computed by extracting the edge information. These matching methods are basically executed on a two-dimensional pattern in the constantly illuminating condition, that is, in the well-conditioned environment.

With recent advance of markets of a monitoring system or a security system, however, in the outdoor actual environment, a request is rising for a technology of recognizing and detecting a target object having a specific pattern from an image picked up by a camera. In this technology, unlike the foregoing well-conditioned environment, a way of viewing a pattern to be detected is greatly varied by the change of an image contrast or the partial shade of the image caused by the variation of the weather or the variation of the brightness in each time band of a day. Further, the object to be detected is not limited to the two-dimensional pattern. It may have a three-dimensional structure such as a vehicle or a human face. Hence, the change of a point of view or the change of posture of an object brings about an apparent transformation of the object. As such, unlike the pattern detection in the well-conditioned environment, the pattern detection in the actual environment may suffer from the change of a size, the apparent change of a form and the variation of illumination at a time. Hence, the use of the method based on the conventional template matching causes the number of templates to be prepared to be massive and thereby requires an unrealistic amount of computation.

As a remedy for these unfavorable conditions, the following two methods may be roughly referred. One method is executed to extract an explicit feature quantity from a pattern, for example, a face organ like eyes, a nose or a mouth if a face is to be detected, and detect the pattern based on the matching between these features. The other method is executed to determine the image itself as a feature vector through a neural network or analyze the main components of the feature vector for reducing the number of dimensions and then to determine the analyzed feature vector through an identifier. In the former method, the detection accuracy of the pattern depends upon the extracting accuracy of the feature quantity. Hence, it is hardly used in the pattern detection in the actual environment. In the latter method, the image itself is basically used as a reference pattern. This method thus does not need a sophisticated pre-process such as detection of face parts and enables to execute the robust search process.

The latter method often uses a differential value of a luminance signal or a feature quantity that is analogous to that differential value indicated in P. Viola and M. Jones: “Rapid Object Detection Using a Boosted Cascade of Simple Features”, Proc. of IEEE Conf. On Computer Vision and Pattern Recognition, 2001. For example, there has been proposed a method based on the wavelet conversion indicated in H. Schneiderman and T. Kanade, “Object Detection Using the Statistics of Parts”, International Journal of Computer Vision, 2002. However, this method is sensitive to the change of luminance and thus needs to applicably change a predetermined threshold value according to the imaging condition or learn the threshold value that is robust to the variation of illumination from a massive amount of learning data.

As another method, the PIS (Peripheral Incremental Sign Correlation) method indicated in Satou, Kaneko, Igarashi, “Robust Object Detection and Separation based on Peripheral Incremental Sign Correlation Image”, Proceedings of the Institute of Electronics, Information and Communication Engineers (IEICE), D-II, Vol. J84-D-II, No. 12, pp. 2585 to 2594, December 2001 or the RRC (Radial Reach Correlation) method indicated in JP-A-2003-141546 may be referred. The former PIS method uses not the foregoing differential luminance value but the incremental signs disclosed as the method using only the differential signs in Murase, Kaneko, Igarashi, “Robust Image Matching based on Incremental Sign Correlation”, Proceedings of the Institute of Electronics, Information and Communication Engineers (IEICE), D-II, Vol. J83-D-II, No. 5, pp. 1323-1331, May 2000. Further, in the PIS, the process is executed to compute a difference of a luminance value between two pixels, that is, a central pixel and a peripheral pixel of an area consisting of 5×5 pixels in the 16 directions vertically, horizontally and slantly from the 5×5 pixels with a remarkable pixel as its center, compute a sign of “1” if the difference is positive or a sign of “0” if it is negative, and compute information of 16 bits consisting of signs in the 16 directions as one pixel. The PIS method uses the 16-bit sign information for executing the pattern matching. Or, the sign information is compared between the background image and the input image and the area having the different sign information from the background is determined as a moving object. This is applied to the detection of an intruder.

In the RRC method, the process is executed to search the luminance values in the eight directions from the remarkable pixel, stop the search if the difference between the luminance value of the searched pixel and the luminance value of the remarkable pixel is equal to or more than a predetermined threshold value, and save the 8-bit incremental signal information at the stopping time. Like the PIS method, the RRC method uses this sign information for executing the pattern matching or detecting a moving object as compared with the background image.

However, for the purpose of the pattern matching, the PIS or the RRC method basically detects only a rigid body. When detecting a moving object, as in the process for a moving image picked up by a fixed camera, the detection is executed only if the background image may be used or the difference information between the frames may be used. Hence, for recognizing a pattern whose appearance is changed by the variation of posture or the variation of illumination in a still image, for example, for detecting a face in a still image, it is quite difficult to directly apply the PIS or the RRC method to the detection.

Therefore, the prior arts disable to correspond with the apparent change caused by the variation of posture of a target object and thus to detect an object with an individual feature belonging to the same area, such as a vehicle or a human's face.

### SUMMARY OF THE INVENTION

It is an object of the present invention to provide a method and an apparatus which are arranged to detect a target object with an individual feature belonging to the same area, such as a vehicle or a human's face with a higher probability in comparison with the foregoing prior arts.

It is a further object of the present invention to provide an identifier which is the most approximate to detecting a pattern by extracting a statistic quality of incremental signs from a database consisting of images to be detected and learning the feature vector derived from the extracted quality.

In carrying out the foregoing objects, according to an aspect of the present invention, a pattern recognizing method for detecting an object is characterized by including the steps of computing an increment from a difference of a luminance value between at least one pixel and another pixel, providing a feature vector composed of incremental sign bit sequences each consisting of the incremental signs of each pixel, obtaining an occurrence probability in an image space of the feature vector from the input image and the image database about the detectable objects, and determining if the input image includes a detectable object belonging to the database based on the occurrence probability of the feature vector.

Moreover, the pattern recognizing method of the present invention is characterized in that, when computing an increment from a difference of a luminance value between at least one pixel and another pixel in the area of the pixels corresponding with the image, the incremental sign is computed as “1” if the value is positive or “0” if it is negative.

Further, the pattern recognizing method according to the present invention is characterized by including the steps of obtaining an occurrence probability of the incremental sign bit sequence that corresponds to each element of the feature vector at each pixel of the image from the database, identifying an object to be detected from the occurrence probability of the incremental sign bit sequence that is proper to the object to be detected and selecting the incremental sign bit sequence that is effective in detecting the object, and detecting the object to be detected or collating the object to be detected with the images of the database by using the feature vector having its bit sequence as the element.

The pattern recognizing method according to the present invention is characterized by including the steps of overlapping a spatial distribution of occurrence probabilities of the incremental sign bit sequences with a spatial distribution of the incremental sign bit sequences computed from an input image, and detecting an object to be detected or collating the object to be detected with the images of the database by using as the feature vector element of the input image at least one of the computed value of the number of pixels having the same incremental sign bit sequence and a value derived by adding the occurrence probabilities of the incremental sign bit sequences at the locations of the pixels having the same incremental sign to one another.

The pattern recognizing method according to the present invention is characterized by including the steps of obtaining an occurrence frequency of each element of the feature vector from both of the database having the images of the objects to be detected and the database having the images of objects not to be detected, obtaining an identifying boundary for identifying the object to be detected from the object not to be detected from the distributions of the occurrence frequencies, and detecting the object to be detected or collating the object to be detected with the images of the database about the objects to be detected.

The pattern recognizing method according to the present invention is characterized by including the steps of, if the object to be detected exists only in a part of the input image, when scanning an area to be detected in the horizontal and the vertical directions and determining if the area to be detected at each scan location is to be detected, generating a partial feature vector by using the pixel with the highest occurrence probability of the incremental sign bit sequence, detecting the object to be detected or collating the object to be detected with the images of the database about the objects to be detected, sequentially adding the information of the pixels with the higher occurrence probability of the incremental sign sequence for updating the partial feature vector, and repeating the detection of the object or the collation of the object with the images of the database about the objects by using the updated partial feature vector with respect to the erroneously detected area, for improving the detection accuracy of the object to be detected.

The pattern recognizing method according to the present invention is characterized by including means for selecting one or more of the pair of pixels within the area with a remarkable pixel as its center at all the locations of the input image, computing a difference of a luminance value from the pair of pixels, and computing a gradient strength sign of “1” if the computed difference is equal to or more than a threshold value set by a user or a threshold value obtained by the learning means from the database or a gradient strength sign of “0” if the former is less than the latter and also computing the incremental signs, and the step of detecting the object or collating the object with the images of the database about the objects to be detected by using both of the incremental signs and the gradient strength signs or only the gradient strength signs.

The pattern recognizing method according to the present invention is characterized by including means for inputting a specific image pattern specified by a user for making sure of an operation of hardware mounted with the pattern recognizing method and the steps of comparing the information to be outputted when this specific image pattern is inputted into the system with the output estimated from the quality of the incremental signs or the gradient strength signs and determining if the hardware is operated normally on the basis of the compared result.

The pattern recognizing method according to the present invention is characterized by inputting a step width on which the area to be detected is moved, a reduction ratio and reduction times provided when the current image is reduced for detecting an object of any size, or generating the partial feature vector, inputting the repeating times of the detection and the collation, and adjusting a frame rate used for processing, a detection ratio of the object, and a collation ratio.

In carrying out the foregoing objects, according to another aspect of the present invention, the pattern recognizing apparatus for detecting an object from an image picked up by a camera is characterized by including feature extracting means for computing an increment from a difference of a luminance value between at least one pixel and another pixel, pattern recognizing means for providing a feature vector with incremental sign bit sequences each consisting of incremental signs of pixels as its elements and obtaining an occurrence probability in an imaging space of the feature vector from an input image and an image database about the object to be detected, and means for determining if the object to be detected belonging to the database exists in the input image in light of the occurrence probability of the feature vector.

Further, the pattern recognizing apparatus according to the present invention is characterized by including operating means for obtaining an occurrence probability of the incremental sign bit sequence that is each element of the feature vector at each pixel of the image selected from the database and pattern recognizing means for selecting the incremental sign bit sequence that is effective in identifying the object to be detected on the basis of the occurrence probability of the incremental sign bit sequence proper to the object to be detected and detecting the object to be detected or collating the object to be detected with the images of the database by using the feature vector with the bit sequences as its elements.

The pattern recognizing apparatus according to the present invention is characterized in that the pattern recognizing means is served to overlap the spatial distribution of an occurrence probability of the incremental sign bit sequence with the spatial distribution of the incremental sign bit sequence computed from the input image and detecting an object to be detected or collating the object to be detected with the images of the database by using as the feature vector element of the input image at least one of the counted value of the number of pixels having the same incremental sign bit sequence and the value derived by adding the occurrence probabilities of the incremental sign bit sequences at the pixels having the same incremental sign.

The pattern recognizing apparatus according to the present invention is characterized in that the pattern recognizing means is served to obtain the occurrence frequency of each element of the feature vector from the database having images of the objects to be detected and the database having images of objects not to be detected, obtain an identifying boundary on which the object to be detected is identified from the object not to be detected in light of the distribution of those occurrence frequencies, and detect the object to be detected or collate the object to be detected with the images of the database about the objects to be detected.

The pattern recognizing apparatus according to the present invention is characterized in that the pattern recognizing means is served to, if an object to be detected exists in only one part of the input image, when scanning the area of the object to be detected in the input image in the horizontal direction and the vertical direction for determining if the area of the object to be detected at each scanning location is to be detected, generate the partial feature vector by using the pixel with the highest occurrence probability included in the incremental sign bit sequence, detect the object to be detected by using this partial feature vector or collate the object to be detected with the images of the database about the objects to be detected, sequentially add the information of the pixels with the high occurrence probability of the incremental sign sequence for updating the partial feature vector, and repeat the detection of the object or the collation of the object with the images of the database about the objects to be detected by using the updated partial feature vector with respect to the erroneously detected area, for improving the detection accuracy of the object to be detected.

The pattern recognizing apparatus according to the present invention is characterized in that the pattern recognizing means includes means for selecting one or more pairs of pixels within the area with a remarkable pixel as its center at all the locations of the input image, computing the incremental signs and a difference of a luminance value from those pairs of pixels, and computing a gradient strength sign of “1” if the computed difference is equal to or more than a threshold value set by a user or a threshold value obtained from the database by learning means or a gradient strength sign of “0” if the former is less than the latter, the means being served to detect the object to be detected or collate the object with the images of the database about the objects to be detected by using both of the incremental signs and the gradient strength signs or only the gradient strength signs.

The pattern recognizing apparatus according to the present invention is characterized by including means for inputting a specific image pattern specified by a user for making sure of the operation of the hardware mounted with the pattern recognizing method, comparing the information to be outputted when the specific image pattern is inputted into the system with the output estimated from the quality of the incremental signs or the gradient strength signs, and determining if the hardware is operated normally.

The pattern recognizing apparatus according to the present invention is characterized by inputting a step width on which the area to be detected is moved, a reduction ratio and reduction times provided when reducing the current image for detecting an object of any size, or repetitive times of the detection or the collation through the partial feature vector generated as parameters required when scanning the area to be detected according to the computing capability of the operating means and adjusting the frame rate used for processing or the detection ratio and the collation ratio of the object.

The present invention may realize the pattern recognizing method and apparatus with the higher detection accuracy by creating a large-scaled image database required for generating the statistic quality of the incremental signs and the feature vector for detecting the pattern generated from the statistic quality.

The pattern recognizing method and apparatus according to the present invention may realize a fast and robust detection through the effect of endurance of the variation of illumination and the proper quality to the incremental signs in which the computing cost is low in a case that the apparent variation of the pattern resulting from the variation of posture of the object to be detected takes place or the target objects having their own individualities and minutely different patterns, such as a vehicle or a human's face, are detected.

Other objects, features and advantages of the invention will become apparent from the following description of the embodiments of the invention taken in conjunction with the accompanying drawings.

### BRIEF DESCRIPTION OF THE DRAWINGS

FIG. 1 is an explanatory view showing the method of detecting a pattern;

FIG. 2 is an explanatory view showing the method of learning a pattern;

FIGS. 3A and 3B are explanatory views showing the method of computing a feature quantity for detecting a pattern;

FIG. 4 is an explanatory view showing the method of computing a feature vector for detecting a pattern;

FIGS. 5A and 5B are explanatory views showing the quality of a feature vector for detecting a pattern;

FIG. 6 is an explanatory view showing an identifying method to be executed when detecting a pattern; and

FIGS. 7A and 7B are explanatory views showing the method of scanning a detection window.

### DESCRIPTION OF THE EMBODIMENTS

Hereafter, the embodiments of the present invention will be described with reference to the appended drawings.

### First Embodiment

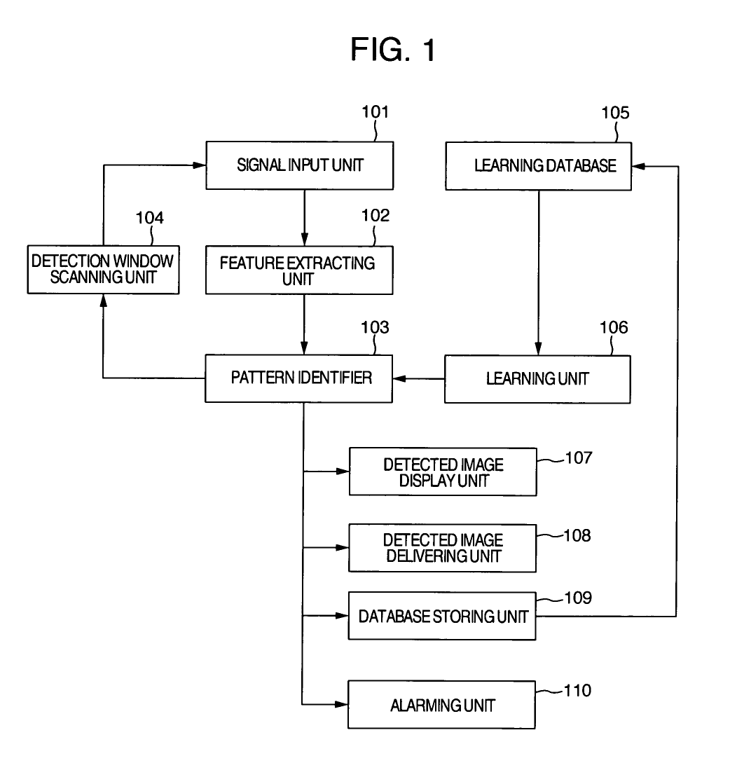

FIG. 1 is a block diagram showing the processing functions of a pattern recognizing apparatus according to an embodiment of the present invention. The pattern recognizing apparatus arranged as shown in FIG. 1 includes a signal input unit 101 being inputted with a signal sent from a camera, a feature extracting unit 102, a pattern identifier 103, a detection window scanning unit 104, a learning database 105, a learning unit 106, a detected image display unit 107, a detected image delivering unit 108, a database storing unit 109 for accumulatively storing detected images, and an alarming unit 110. Those functional blocks for executing the corresponding operations are configured with software on a system built in a computer provided with a CPU. The learning database 105 is configured in a storage unit such as a memory or a hard disk.

In this embodiment, the blocks of the signal input unit 101 to the detection window scanning unit 104 are intended to determine if an input signal is to be detected. The learning database 105 and the learning unit 106 are intended for learning. The result learned in the blocks 105 and 106 is passed to the pattern identifier 103 in which a target pattern may be detected. The blocks of the detected image display unit 107 to the alarming unit 110 are intended for making use of the detected result. The detected result is displayed on the detected image display unit 107 so that the detected result may be used for a guidance of a security system. The detected image delivering unit 108 is a block of delivering only the detected result to a network. For example, it is used only in the scene where a person enters into or leaves a room or in the case that a watcher wants to watch only the image appearing when a vehicle is detected in a monitoring system. The database storing unit 109 is intended for storing detected images. For example, it is used in the case of creating a history of persons entering into a certain zone. Further, by storing only the detected result images, the images may be stored for a long time even in the instrument provided with a relatively small storage amount. The alarming unit 110 is used for a security system. For example, a number plate is recognized on the detected result of a vehicle for analyzing traffics of vehicles. Or, a face is authenticated on the detected result of a human's face for the purpose of managing persons entering into or leaving a room or preventing incorrect use of a license.

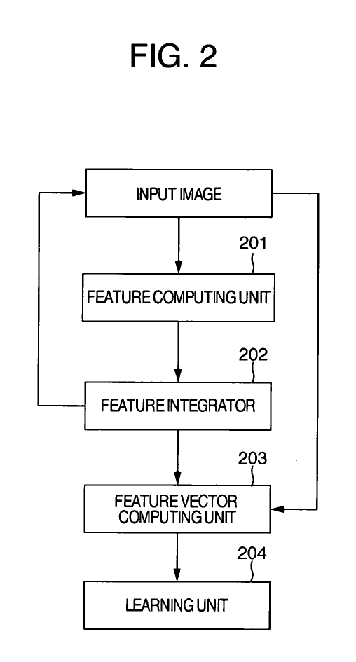

In advance of detecting a target object, the learning unit 106 extracts feature information about the object and learns it. The process and the contents of this learning unit 106 will be described below with reference to FIG. 2.

In the embodiment shown in FIG. 2 are provided functional blocks of a feature computing unit 201, a feature integrator 202, a feature vector computing unit 203, and a learning unit 204. The flow of the process in the learning unit 106 is as follows. An input image is sequentially sent from the learning database 105 to the feature computing unit 201, in which an incremental sign is computed at each pixel of the image. Then, this incremental signs are integrated in the feature integrator 202 in the foregoing sequential inputting process. These processes are repeated until all the images in the database are processed. Then, the feature vector computing unit 203 outputs an occurrence frequency of the incremental sign. Hereafter, the learning unit 106 will be described in more detail.

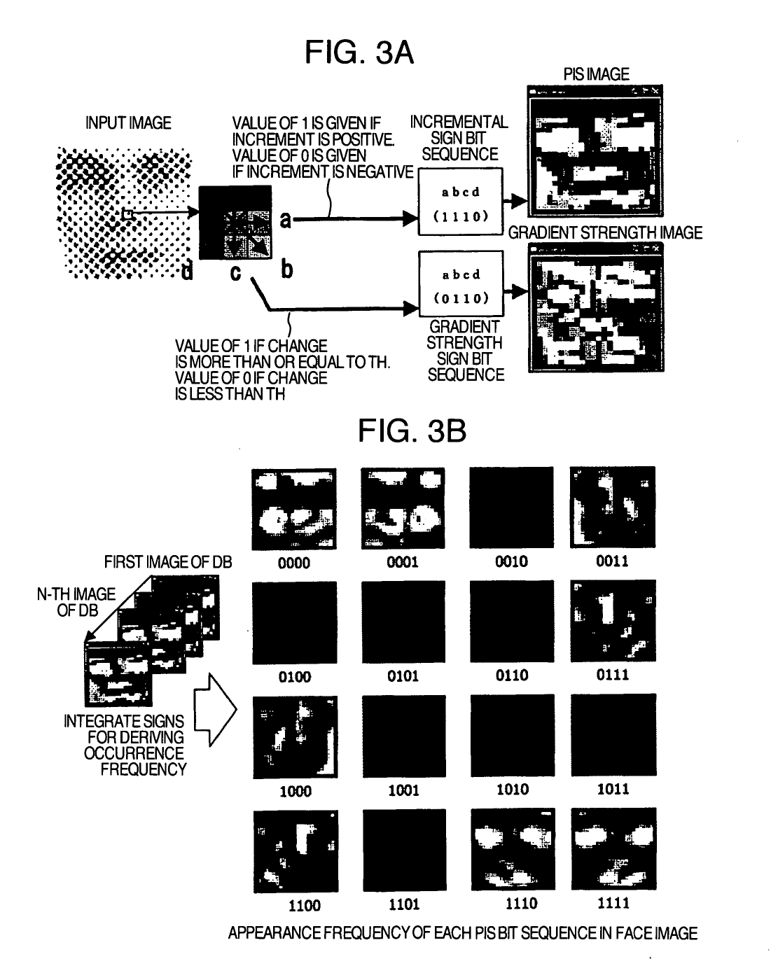

The processed contents of the feature computing unit 201 shown in FIG. 2 are described in detail with reference to FIG. 3A. In the feature computing unit 201, consider a square area with a remarkable pixel as its center, for example, an area consisting of 3×3 pixels in each pixel location of the input image. Of course, this area is not limited to a format of 3×3 pixels. It is optional. Hence, it may be magnified up to the maximum size of the input image. At least one pair of pixels is selected in this area and then the difference of the luminance value is computed. The incremental sign bit is defined to have a value of “1” if the difference is positive or a value of “0” if the difference is negative. The resulting incremental sign bit sequence has the number of pairs of pixels as its element number. In FIG. 3A, as an example, in the area consisting of 3×3 pixels, the difference of the luminance value is computed in the four, that is, vertical, horizontal, right oblique and left oblique directions a, b, c and d are computed, for deriving a four-bit incremental sign sequence. This incremental sign is termed the PIS (Peripheral Incremental Sign Correlation) in the “Robust Object Detection and Separation based on Peripheral Incremental Sign Correlation Image”,. Hereafter, this term is used for the incremental sign. Further, the four-bit (2⁴) PIS displayed in luminance is called a PIS image. In the leftmost of FIG. 3A is shown the PIS image for the input image. The PIS represents the incremental sign of the luminance value in bits. Instead, a gradient strength bit sequence may be defined to have a value of “1” if the difference of the luminance value between the two pixels is equal to or more than a certain threshold value or a value of “0” if the former is less than the latter and may be used for representing the incremental sign of the luminance value in bits. In this case, the gradient strength image is generated in a manner to correspond with the PIS image. These bit-representations may be used in the later processes solely or in concert.

In the feature integrator 202 shown in FIG. 2, the foregoing PIS image or the gradient strength image computed with respect to the image of the same object stored in the image database and then overlapped therewith. This processed result is shown in FIG. 3B. Assuming that N images are stored in the database, the bits of the PIS or the gradient strength signs are individually overlapped. As a result, as shown in FIG. 3B, the appearance frequencies corresponding with the PIS bit sequences of 2⁴=16 for each sign of a, b, c and d. It is indicated in FIG. 3B that for a brighter pixel, the appearance frequency of the sign is higher. FIGS. 3A and 3B illustrate a human's face as an object to be detected. As will be understood from the images of the appearance frequencies of the PIS bit sequences, the appearance frequency of the PIS bit sequence is specific to the gradient direction of each face's part. For example, the PIS bit sequences “1111” and “1110” represent eyes and eyebrows and a mouth and the PIS bit sequences “0111” and “1100” represent a nose.

As such, in the PIS bit sequences “1111” and “1110”, the image is vertically changed, while in the PIS bit sequences “0111” and “1100”, the image is horizontally changed.

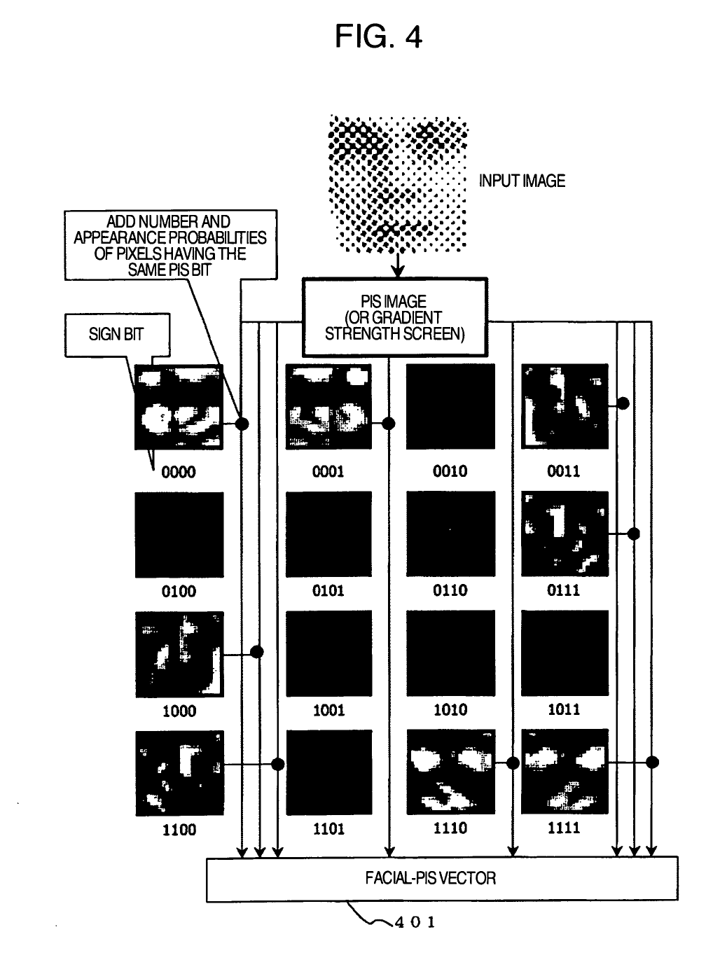

Then, the feature vector with the PIS bit sequences for detecting a target object as the elements is generated in the feature vector computing unit 203 shown in FIG. 2. The detailed processing content of the feature vector computing unit is described with reference to FIG. 4. At first, the PIS image is computed with respect to the input image. Then, the PIS image is overlapped on the distribution of the PIS bit sequences shown in FIG. 3B. If a match takes place between the PIS bit sequence of the image stored in the image database and the PIS bit sequence of the input image at each pixel location, the number of matched pixels and the appearance frequencies are individually accumulated for each PIS bit. When these processes are terminated about all the pixels of the input image, finally, the feature vector is computed with respect to the input image (see a block 401 of FIG. 4). Since the human's face is an example, the computed feature vector is called the Facial-PIS vector. Herein the Facial-PIS's with a lower occurrence frequency, concretely, the sign bits “0010”, “0100”, “0101”, “0110”, “1001”, “1010”, “1011”, “1101” are not used for the feature vector. On the other hand, the sign bits “0000”, “1000”, “1100”, “0001”, “1110”, “0011”, “0111” and “1111” are used for the feature vector. In this embodiment, the human's face is shown as the Facial-PIS feature vector. This method may be applied not only to the human's face but also to the characters or the vehicle, that is, the image having a specific pattern to be used by a person for identification.

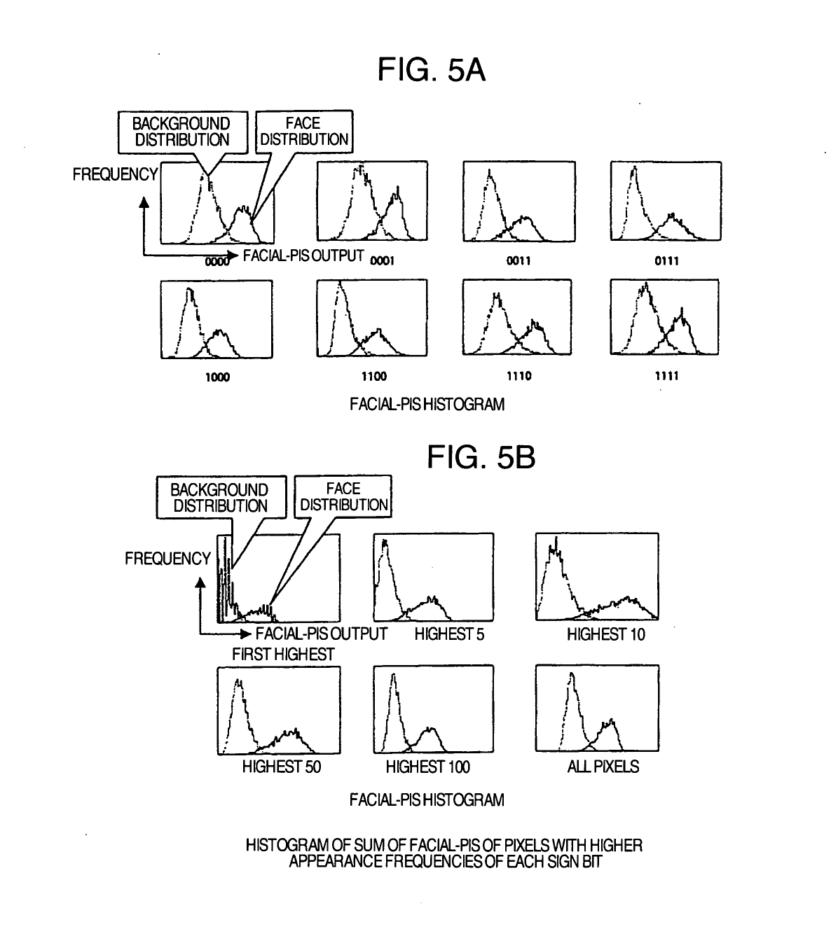

For detecting a human's face through the use of the Facial-PIS vector, the contents of the process to be executed by using the quality of this vector will be described with reference to FIGS. 5A and 5B. FIG. 5A shows the image information of a face image database and a background image database and a histogram of each element of the foregoing Facial-PIS vector. In FIG. 5A, an axis of abscissa denotes a degree of match of a magnitude of a vector element that is an output value of each element of the Facial-PIS. A larger value indicates a higher degree of match. An axis of ordinate denotes a counted value of how frequently a value indicated in the axis of abscissa occurs in the image database. As will be understood from FIG. 5A, the Facial-PIS output for the background image is wholly made smaller, while the Facial-PIS output for the face image is made wholly made larger. By using this characteristic, it is possible to identify the face from the background by specifying a crossed point of the histograms as a threshold value as simply referring to the Facial-PIS distributions of the face and the background. In this case, however, the erroneous identification may be carried out in the overlapped area of the histograms. For preventing the erroneous identification, the Facial-PIS vector about the concerned area may be passed through the identifier for the purpose of identifying the face from the background. The identifier may be the Bayesian inference method, a neural network, a support vector machine, a boosting method, or the like.

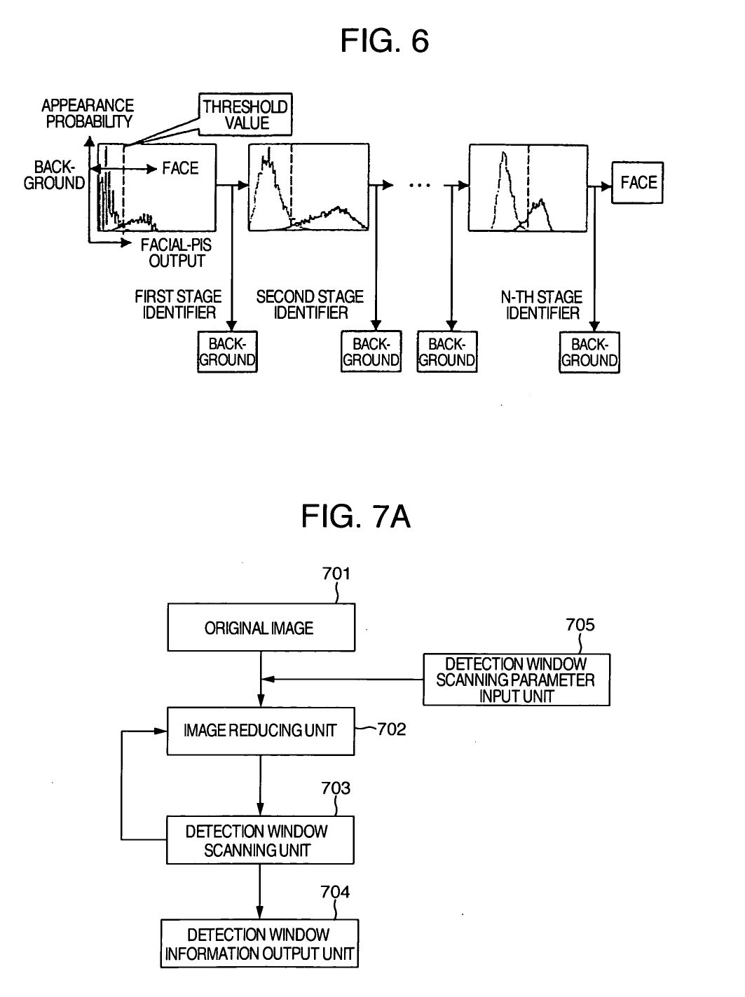

The foregoing identifying method concerns with the process of a categorized image such as a face and a background being directly inputted into the pattern recognizing apparatus. If an input image is picked up by a camera, the location and the size of the object to be detected are variously changed. Hence, by shifting the location of the window as changing the size of the detection window on the image, it is necessary to identify a face from a background at each location. In this case, since the collating times are made massive by the window scanning, it is necessary to reduce the amount of computation for the way of use such as the monitoring system or the security system that requires the real-time processing. Herein, description will be oriented to the method of speeding up the process by devising the computation of the Facial-PIS, though the method of the detection window scanning is described later. FIG. 5B shows the contents of process to be executed through the use of the quality of the Facial-PIS that makes the rapid detection possible. Unlike FIG. 5A, the axis of abscissa denotes an output value of a sum of the Facial-PIS vector elements. The histogram shown in FIG. 5A uses all the pixels of the detection window, while the histogram shown in FIG. 5B uses a sum of the Facial-PIS vector elements selected from the pixels with a higher appearance frequency. As will be understood from FIG. 5B, even in the case of using only the upper pixel with the highest appearance frequency of the Facial-PIS, it is understood that the face distribution is separated from the background distribution. That is, assuming that the detection window consists of 24×24 pixels and the number of all pixels in the window is totally 576, in the case of using only one pixel with the highest appearance frequency of the Facial-PIS, an amount of computation of 1/576 is just required for the detecting process. This characteristic makes it possible to carry out the rough detecting process including the excessive detection through the use of a relatively small number of pixels, increase the number of pixels to be used for detection, and carry out a constricting detection in a cascade manner. This process will be described below with reference to FIG. 6.

In the process shown FIG. 6, the identifier located at the first stage operates to compare the Facial-PIS output derived through the use of the pixel with the highest appearance frequency with the appearance probability of a degree of match of the background distribution and then determine that the input image is the background if the appearance probability of a degree of match of the background distribution is smaller than a threshold value.

In a case that this identifier at the first stage has difficulty in discriminating the background from the target object on the threshold value, the process shifts to the identifier located at the second stage. This identifier operates to compare the Facial-PIS output derived through the use of the pixel with, for example, the ten highest appearance frequencies with the appearance probability of a degree of match of the background distribution and then determines the input image is the background if the appearance probability of a degree of match of the background distribution is smaller than the threshold value of this identifier. If the input image is not still determined as the background, the process shifts to the next identifier.

As described above, by comparing the Facial-PIS output for the identifiers at N stages with the background distribution, it is determined that the image with a smaller appearance probability than the threshold value is the background. The image data whose appearance probability is not finally made smaller than the threshold value is determined as a face image.

This process makes it possible to speed up the detecting process without having to use all pixels located within the detection window from the outset and having to skip the scan on the detection window. FIG. 5B illustrates the Facial-PIS distributions of the highest pixel, the fifth highest pixel, the tenth highest pixel, the 50th highest pixel, the 100th highest pixel, and all pixels. Herein, the excessive detection and the detection leakage may be brought about depending upon the threshold value on which the face is separated from the background at each stage. The most approximate threshold value may be learned through the effect of the foregoing Bayesian inference method, the neural network, the support vector machine, and the boosting method according to the database and the way of use.

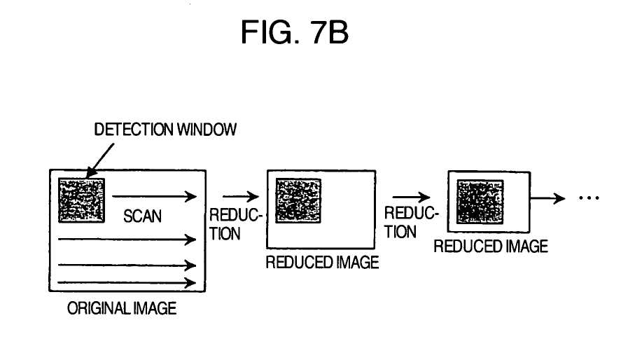

Then, the method of scanning the detection window will be described with reference to FIGS. 7A and 7B. Herein, as reducing the current image without changing the size of the detection window, a relatively larger detection window may be scanned. At first, when a current image 701 is inputted, the image is reduced at a given reduction ratio in an image reducing unit 702. Then, a detection window scanning unit 703 operates to shift the detection window of a fixed size a constant number of pixels by a constant number of pixels in the scanning direction. Then, the coordinate value of the scanning location is outputted from a window information output unit 704. In FIG. 1, the coordinate value is outputted from the block 104 of FIG. 1. The pixels within the detection window are clipped from the current image through the use of this coordinate value and then are passed to the signal input unit 101 of FIG. 1. This process is repeated until the detection window completes the scanning on the screen. When the scanning is terminated on the reduced image, the image is again reduced at the foregoing reduction ratio, and the scan is started on the reduced image. The reducing process is repeated until the height and the width of the reduced image are made the same as those of the detection window. Herein, the parameters required for scanning the detection window, concretely, the reduction ratio of an image, a number of pixels to be shifted for scanning the detection window, a detection window size, and times of image reduction, are inputted from a detection window scanning parameter input unit 705 shown in FIG. 7. The role of this input unit is to adjust the processing time and the detection accuracy by adjusting the detection window scanning parameters. For example, in the case of using a processor with a high computing capability, by minutely changing the values of the parameters for corresponding with the minute changes of the size and the location of the detection window, it is possible to enhance the detection sensitivity of the target object. On the other hand, in the case of using a processor with a low computing capability, by greatly changing the values of the parameters, it is possible to reduce the amount of computation. For example, though the amount of computation is reduced by enlarging the shifting width used in scanning the detection window, the detection accuracy is made lower. Or, though the amount of computation is reduced by greatly changing the image reduction ratio, the detection leakage of the object of the middle size is brought about. Further, by reducing the times of reducing the image, it is possible to reduce the amount of computation. In this case, though no detection is allowed in an original image, that is, a non-reduced image, if the size of the image is presumed on the screen to be detected, this is served as the processing means that is effective in enhancing the detection speed.

The foregoing setting of the parameters for the detection window is effective, for example, in the case that the pattern detection is required by the built-in instrument. The built-in instrument does not often mount such a high-speed processor as using the personal computer in light of power consumption, heating amount and cost. Hence, it is necessary to mount a built-in microcomputer or DSP that consumes low power and heat and is less costly. For example, it may be a hard disk recorder to be operated in a standalone manner, a DCCTV, a small-sized image processing unit, or the like. In the case of detecting a pattern with this sort of instrument, by adjusting the parameters for scanning the detection window, it is possible to reduce such an amount of computation as being processed by the built-in microcomputer or the DSP. Instead, in a case that the built-in instrument is viewed from a client though the detecting capability is made lower, the corresponding system may be configured so that the client is caused to output the excessively detected result with the detection leakage being suppressed as much as possible, send the detected result to a server having a rapidly computable processor mounted therein, and finally process the detection in the server. Since all the picked-up images are not sent from the client, even if the clients are increased in number, the amount of computation is not saturated. As another advantage, the saving area of data is consumed.

The processing functional blocks and the processing means for executing the foregoing series of operations are configured as software on the system configured by a computer provided with a CPU and are processed by the computer. Those blocks may be configured in various kinds of electronic computer systems. Those blocks may be also configured in a built-in instrument or a one-chip image processing processor.

In the foregoing embodiments, the PIS is the incremental signs of the luminance value represented in bits. However, as mentioned above, the gradient strength bit sequence may be defined for that purpose.

The foregoing embodiments have mainly concerned with detection of a human's face. Instead, the present invention may be applied to detection of a human's body, characters, symbols, or a vehicle.

It should be further understood by those skilled in the art that although the foregoing description has been made on embodiments of the invention, the invention is not limited thereto and various changes and modifications may be made without departing from the spirit of the invention and the scope of the appended claims.

1. A pattern recognizing method for detecting an object from an image picked up by a camera, comprising the steps of:
computing an increment from a difference of luminance values between at least one pixel and another pixel of an input image;
providing a feature vector having as its elements incremental sign bit sequences each consisting of signs derived from said increments between pixels, and obtaining an occurrence probability in an imaging space of said feature vector from the input image and a database having image data about objects to be detected; and
determining if said input image includes an object belonging to said database on the basis of said occurrence probability of said feature vector.

2. The pattern recognizing method as claimed in claim 1, wherein when computing said increment from a difference of luminance values between at least one pixel and another pixel in the pixel area corresponding with said image, said incremental sign is derived to have a value of “1” if the computed increment is positive or a value of “0” if it is negative.

3. The pattern recognizing method as claimed in claim 1, further comprising the steps of:
obtaining an occurrence probability of said incremental sign bit sequence that corresponds to each element of said feature vector at each pixel location of said image from said database;
identifying said object to be detected on the basis of the occurrence probability of said proper incremental sign bit sequence to said object to be detected and selecting said incremental sign bit sequence being effective in said detection; and
detecting said object or collating said object to be detected with the image data of said database by using the feature vector with said bit sequences as its elements.

4. The pattern recognizing method as claimed in claim 3, further comprising the steps of:
overlapping a special distribution of the occurrence probabilities of said incremental sign bit sequences with a spatial distribution of the incremental sign bit sequences computed from said input image; and
detecting said object or collating said object with the images of said database with at least one of a counted value of pixels having the same incremental sign bit sequence and an added value of the occurrence probabilities of said incremental sign bit sequences at the locations of the pixels having the same incremental sign as the feature vector element of the input image.

5. The pattern recognizing method as claimed in claim 1, further comprising the steps of:
obtaining an occurrence frequency of each element of said feature vector from a database having image data of objects to be detected and a database having image data of objects not to be detected;
obtaining an identifying boundary on which said object to be detected is identified from said object not to be detected from the distribution of said occurrence frequencies; and
detecting said object or collating said object with the image data of said database about said objects to be detected on the basis of said identifying boundary.

6. The pattern recognizing method as claimed in claim 1, further comprising the steps of:
when said object to be detected exists in only part of said input image and determining if an area of said object to be detected at each scanning location is to be detected by horizontally and vertically scanning said area in said input image, generating a partial feature vector by using pixels with the highest occurrence probability of said incremental sign bit sequence;
detecting said object or collating said object with the image data of said database about said objects to be detected by using said partial feature vector, and sequentially adding the information of the pixels with the higher occurrence probability of said incremental sign sequence for updating said partial feature vector; and
repeating detection of said object or collation of said object with the image data of said database about said objects to be detected by using said partial feature vector updated with respect to an erroneously detected area, for improving detection accuracy of said object to be detected.

7. The pattern recognizing method as claimed in claim 1, in which means is provided for computing said incremental sign and a gradient strength sign, said gradient strength sign being defined to have a value of “1” if the value, derived by selecting one or more pairs of pixels within an area with a remarkable pixel as its center at all the locations of said input image and computing a difference of luminance values from the selected pair of pixels, is equal to or more than a threshold value set by a user or a threshold value obtained from said database by learning means or a value of “0” if said value is less than said threshold value, and further comprising the step of detecting said object or collating said object with the image data of said database about said objects to be detected by using only said gradient strength signs or both of said incremental signs and said gradient strength signs.

8. The pattern recognizing method as claimed in claim 1, wherein means is provided for inputting a specific image pattern specified by a user for making sure of the operation of hardware mounted with said pattern recognizing method, and further comprising the step of comparing information to be outputted when said specific image pattern is entered into a system with an output estimated from the quality of said gradient strength signs, for determining if said hardware is operated normally.

9. The pattern recognizing method as claimed in claim 1, further comprising the steps of:
inputting a step width on which said object area is moved, a reduction ratio and reduction times provided when reducing the current image for detecting an object of any size, and repeating times of said detection or collation through said partial feature vector generated as parameters used for scanning said object area according to a computing capability of operational processing means; and adjusting a frame rate used for processing, a detection ratio of said object and a collation ratio.

10. A pattern recognizing apparatus for detecting an object from an image picked up by a camera, comprising:
feature extracting means for computing an increment from a difference of luminance values between at least one pixel and another pixel of an input image;
pattern recognizing means for providing a feature vector having incremental sign bit sequences each consisting of signs derived from said increments between said pixels as its elements and obtaining an occurrence probability in an imaging space of said feature vector from an input image and a database having image data of objects to be detected; and
means for determining if said input image includes an object to be detected belonging to said database on the basis of said occurrence probability of said feature vector.

11. The pattern recognizing apparatus as claimed in claim 10, further comprising:
operating means for obtaining an occurrence probability of said incremental sign bit sequence that corresponds to each element of said feature vector at the location of each pixel of said image from said database; and
pattern recognizing means for recognizing said object to be detected from an occurrence probability of said incremental sign bit sequence that is proper to said object to detected, selecting said incremental sign bit sequence being effective in detection, and detecting said object to be detected or collating said object with the image data of said database about the objects to be detected by using said feature vector having said bit sequences as its elements.

12. The pattern recognizing apparatus as claimed in claim 10, wherein said pattern recognizing means is served to overlap a spatial distribution of the occurrence probabilities of said incremental sing bit sequences with a spatial distribution of incremental sign bit sequences computed from said input image and to detect said object or collate said object with the image data of said database with at least one of the counted value of the pixels having the same incremental sign bit sequence and the value derived by adding the occurrence probabilities of said incremental sign bit sequences at the locations of the pixels having the same incremental sign as the feature vector elements of said input image.

13. The pattern recognizing apparatus as claimed in claim 10, wherein said pattern recognizing means is served to obtain an occurrence frequency of each element of said feature vector from both of a database having the image data of said objects to be detected and a database having the image data of objects not to be detected, obtaining an identifying boundary on which said object to be detected is identified from said object not to be detected from the distribution of said occurrence frequencies, and detect said object or collate said object with the image data of said database about said objects to be detected.

14. The pattern recognizing apparatus as claimed in claim 10, wherein said pattern recognizing means is served to generate a partial feature vector by using pixels with the highest occurrence probability of said incremental sign bit sequence when said object to be detected exists in only part of said input image and it is determined if an area of said object is to be detected at each scanning location by horizontally and vertically scanning said area on said input image, detect said object or collate said object with the image data of said database about said objects to be detected by using said partial feature vector, sequentially add the information of the pixels with the higher occurrence probability of said incremental sign sequence for updating said partial feature vector, and repeat detection of said object or collation of said object with the image data of said database about said objects to be detected by using updated partial feature vector with respect to an erroneously detected area, for improving detection accuracy of said object.

15. The pattern recognizing apparatus as claimed in claim 10, wherein said pattern recognizing means includes means for computing said incremental signs and gradient strength signs, said gradient strength signs being defined to have a value of “1” if a value, derived by selecting at least one pair of pixels within an area with a remarkable pixel at all the locations of said input image, and computing a difference of luminance values from said pair of pixels, is equal to or more than a threshold value set by a user or obtained from said database by learning means or a value of “0” if said value is less than said predetermined value, and said pattern recognizing means is served to detect said object or collate said object with the image data of said database about said objects to be detected by using both of said incremental signs and said gradient strength signs or by using only said gradient strength signs.

16. The pattern recognizing apparatus as claimed in claim 10, further comprising means for inputting a specific image pattern specified by a user for making sure of an operation of hardware mounted with a pattern recognizing method and wherein information to be outputted when inputting said specific image pattern into a system is compared with the output estimated from the quality of said incremental signs or said gradient strength signs, for determining if said hardware is operated normally.

17. The pattern recognizing apparatus as claimed in claim 10, wherein a step width on which said object area is moved, a reduction ratio and reduction times provided when reducing a current image for detecting an object of any size, and repeating times of said detection or collation through said partial feature vector generated are inputted as parameters used for scanning said object area, for adjusting a frame rate used for processing, a detection ratio of said object and a collation ratio.
